(19) United States
(12) Patent Application Publication
(10) Pub. No.: US 2008/0248371 A1
(43) Pub. Date: Oct. 9, 2008

(54) FUEL CELL WITH A PASSAGE STRUCTURE

(75) Inventors: Fang-Bor Weng, Jhongli City (TW); Ay Su, Jhongli City (TW); Po-Hsien Chou, Jhongli City (TW); Pai-Ho Hsu, Jhongli City (TW)

Correspondence Address: EGBERT LAW OFFICES, 412 MAIN STREET, 7TH FLOOR, HOUSTON, TX, 77002, US

(73) Assignee: YUAN ZE UNIVERSITY, Jhongli City (TW)

(21) Appl. No.: 11/695,902

(22) Filed: Apr. 3, 2007

(51) Int. Cl. H01M 2/08

(52) U.S. Cl. 429/35

(57) ABSTRACT

The fuel cell with a passage structure includes several power generating modules separately provided for forming the passage structure. The power generating modules are formed into a fully-sealed or notched cylinder having an external wall and a hollow space. The power generating modules are superimposed and assembled into a hydrogen guide passage and oxygen guide passage by the misaligned internal sealing member and external sealing member. So, the hydrogen and oxygen can be guided separately into the power generating modules. With this unique circular passage, it is possible to expand the cross-section and to improve the directional properties of the oxygen and hydrogen guide passages, thus promoting transfer efficiency of oxygen and hydrogen and greater industrial practicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a fuel cell, and more particularly to a fuel cell with an innovative passage structure.

2. Description of Related Art Including Information Disclosed Under 37 CFR 1.97 and 37 CFR 1.98

The fuel cell is used to convert chemical energy stored in fuel and an air into electrical energy. It can generate power continuously if provided externally with fuel and an air. Without the limitations of the Carnot cycle, the fuel cell of a modular structure features high energy conversion efficiency and power as a clean and pollution-free unit. It is suitable for centralized power generation and distributed power supply, avoiding energy conversion loss by a thermal generator set (through boilers and steam turbine) and achieving an extremely high power generating efficiency. Thus, the fuel cell is a better choice of power generating unit.

In field applications, an integral fuel cell combines a fuel storage unit, a power generating unit and an enclosure. The power generating unit is generally composed of several power generating modules, among which a passage is formed to transfer the liquid fuel (e.g hydrogen, oxygen). Thus, the passage structure plays a crucial role in guaranteeing efficient and smooth fuel transfer.

The passage structure of a fuel cell is typically formed by a parallel or serpentine structure in order to fit rectangular power generating modules. The passage is generally placed on the flow plate. However, the actual cross section of the passage is segmented into smaller sections, leading to lower transfer efficiency and smoothness. Meanwhile, more material and processing costs are required. From another perspective, the parallel or serpentine passage structures are gradually constrained by the inlet and outlet, since fuel cells are constantly developed to meet demanding industrial requirements. For example, if the power generating unit and enclosure are formed into a cylindrical structure, the parallel or serpentine passage structure cannot provide a desirable fuel transfer effect due to the single direction and orientation of the inlet and outlet.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The power generating modules 21 of the fuel cell of the present invention are formed into a circular structure to form an external wall 22 and a hollow space 23. Moreover, the power generating modules 21 are superimposed into hydrogen guide passage 26 and oxygen guide passage 27 by the misaligned internal sealing member 24 and external sealing member 25. Thus, the hydrogen and oxygen fuel can be guided separately into the power generating module 21. With this unique circular passage structure, it is possible to expand the cross section of the passage structure and improve the directional properties, thus greatly improving the transfer efficiency of oxygen and hydrogen.

The power generating modules 21 are superimposed to form a laminated layer using the diffusion layer 211, metal isolating layer 213, internal sealing member 24 and external sealing member 25. Thus, an innovative passage with a simplified structure minimizes the material cost and increases industrial practicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows an exploded perspective view of components of the fuel cell in the preferred embodiment of the present invention.

FIG. 3 shows an assembled perspective view of the preferred embodiment of the present invention.

FIG. 4 shows an assembled sectional view of the preferred embodiment of the present invention.

FIG. 5 shows an enlarged sectional view of location B in FIG. 4.

FIG. 6 shows another sectional view of a fuel cell of the present invention.

FIG. 7 shows a cross-sectional view of the power generating module of the present invention.

FIG. 8 shows a cross-sectional view of the hollow space of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

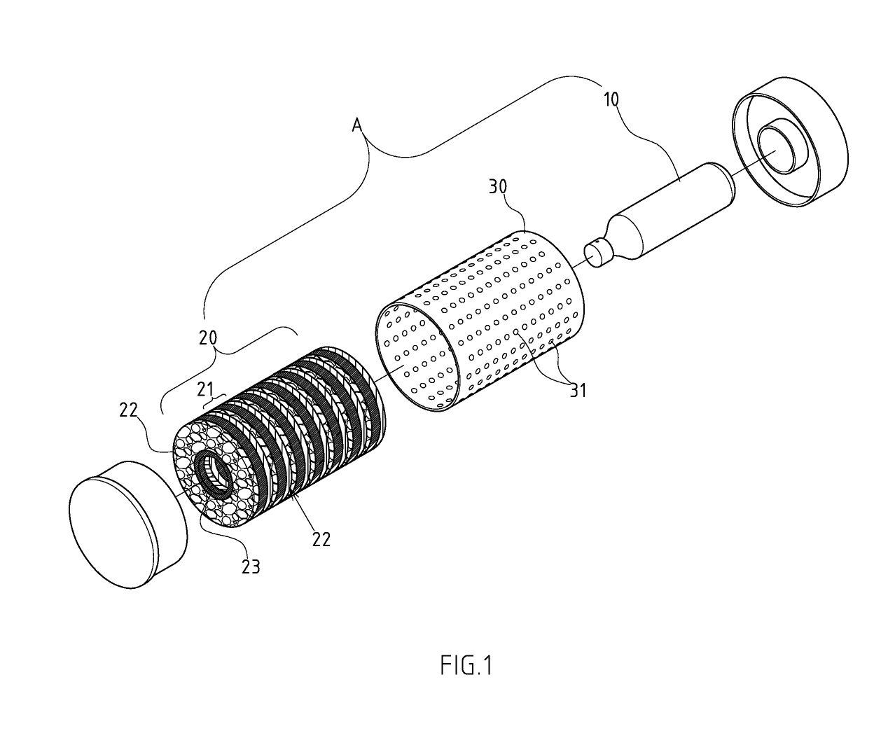

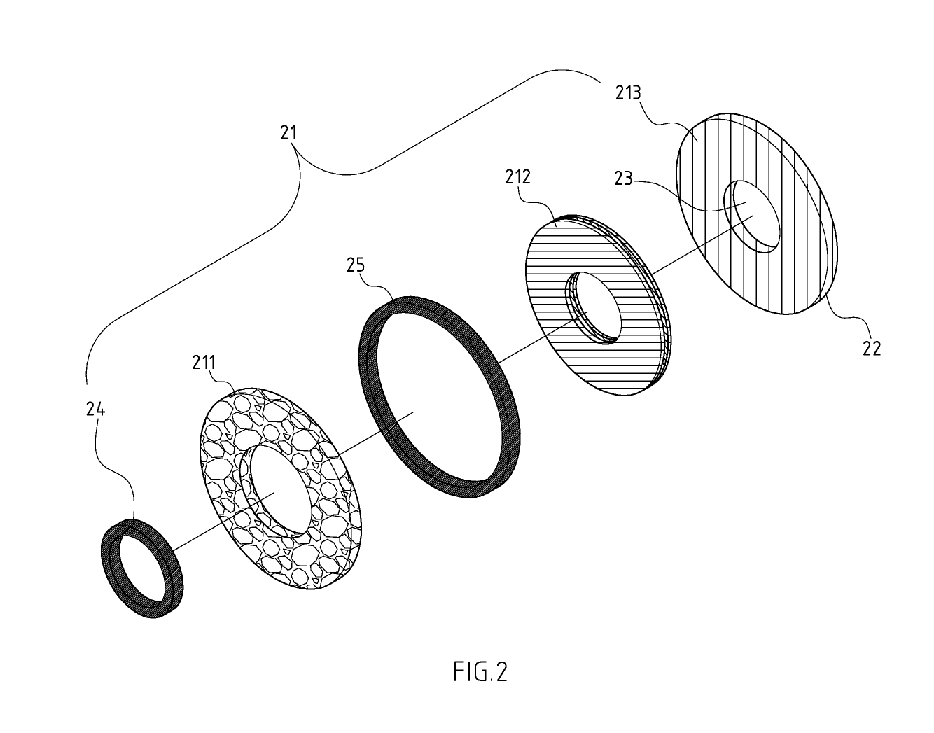

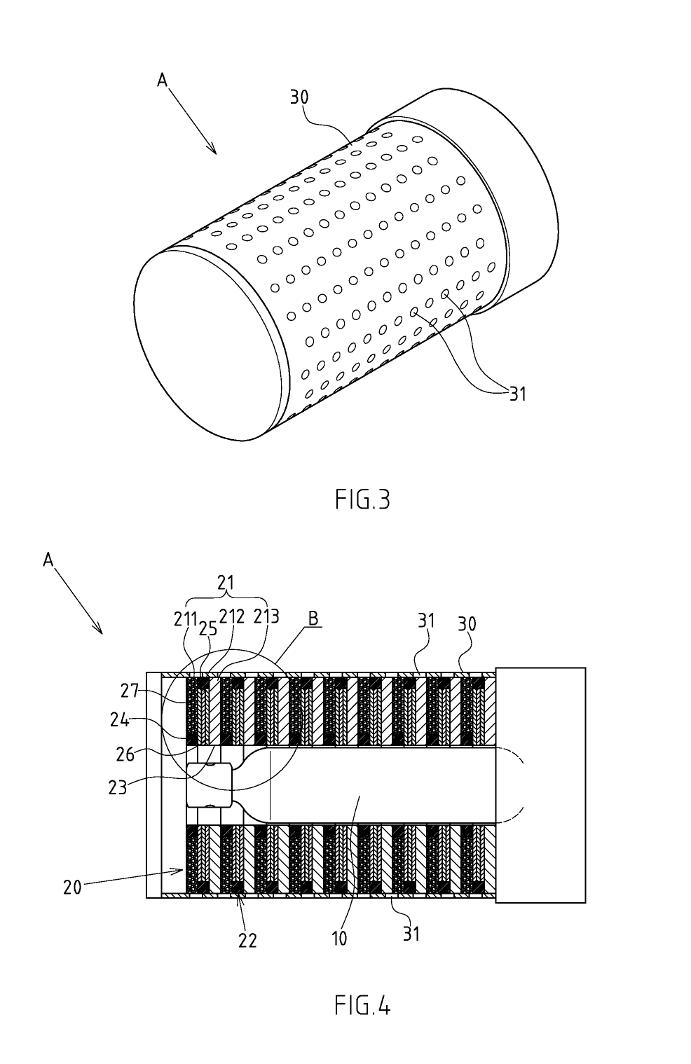

FIGS. 1 and 2 depict a preferred embodiment of the improved fuel cell structure of the present invention. The preferred embodiment is provided only for explanatory purposes. The scope of the patent is set by the claims.

The fuel cell A of the present invention includes a hydrogen storage unit 10, such as a hydrogen tank, a power generating unit 20 and an enclosure 30. The power generating unit 20 is composed of several power generating modules 21 separately mounted within a passage in the fuel cell A.

The power generating module 21 is a fully-sealed or notched cylinder, forming an external wall 22 and at least a hollow space 23. The power generating module 21 of the preferred embodiment is a round cylinder.

The power generating modules 21 are superimposed, and also assembled into a hydrogen guide passage 26 and oxygen guide passage 27 by the misaligned internal sealing member 24 and external sealing member 25. So, the hydrogen and oxygen can be guided separately into the power generating modules 21 to generate electrical energy after the expected chemical reaction.

The power generating module 21 is superimposed by an annular metal diffusion layer 211, a MEA 212 and a metal isolating layer 213, such that the internal sealing member 24 is placed circularly within the metal diffusion layer 211. The external sealing member 25 is placed circularly outside of MEA 212. Moreover, the oxygen guide passage 27 is shaped by the metal diffusion layer 211, while the hydrogen guide passage 26 is shaped nearby the metal isolating layer 213 of MEA 212. The metal diffusion layer 211 may have a capillary structure made of foamed metal materials, such that oxygen can be diffused and guided into MEA 212. The MEA 212 is an element of power generating module 21, where hydrogen and oxygen are gathered to yield the chemical reaction and then electrical energy.

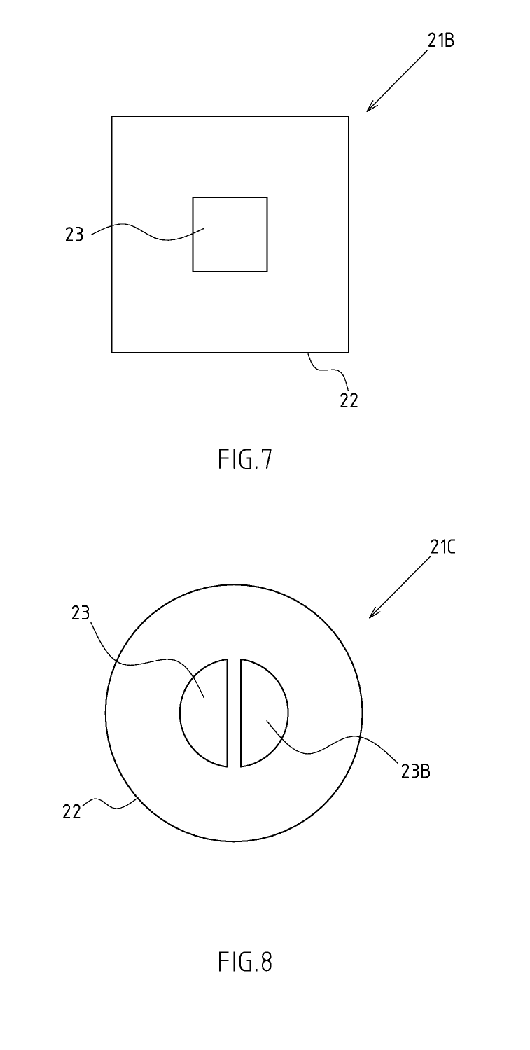

In addition to the aforementioned round shape, the power generating module 21B disclosed in FIG. 7 can be a rectangular cylinder. Alternatively, the power generating module can also be a polygonal cylinder.

The enclosure 30 may be a cylinder with some air holes 31, whereby oxygen can flow into oxygen guide passage 27 formed by metal diffusion layer 211 of the power generating modules 21.

The hollow space 23 formed by the power generating module 21 could be used to accommodate the hydrogen storage unit 10 (shown in FIG. 4).

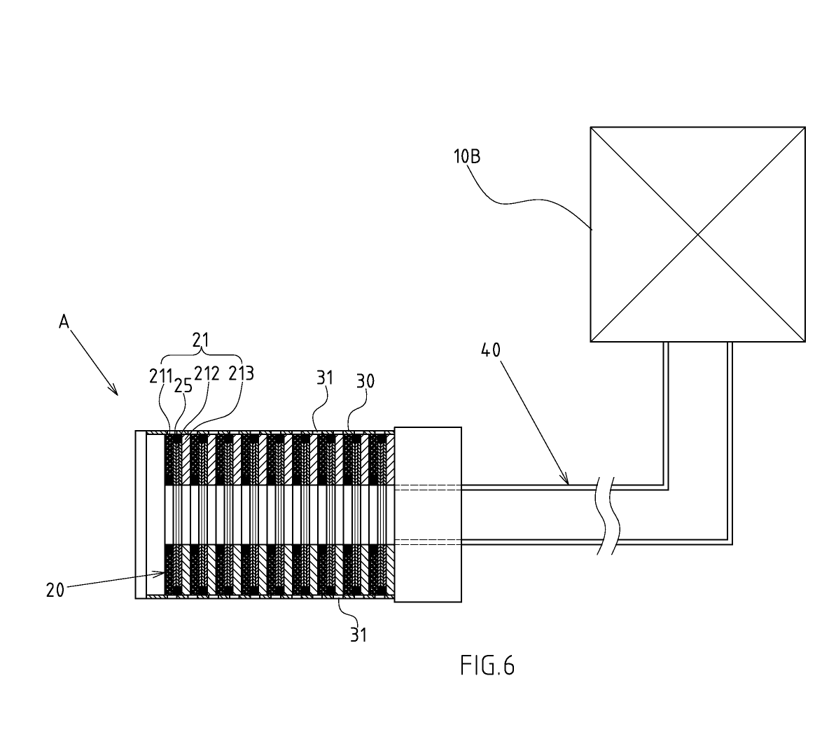

Referring to FIG. 6, the hollow space 23 formed by the power generating module 21 can also be used as hydrogen guide channel, such that the hollow space 23 can be linked to hydrogen storage unit 10B via pipeline 40.

The hollow space 23 of power generating module 21 may be a single hollow space, or a double hollow space 23, 23B as disclosed in FIG. 8.

Based upon the above-specified structures, the present invention is operates as follows:

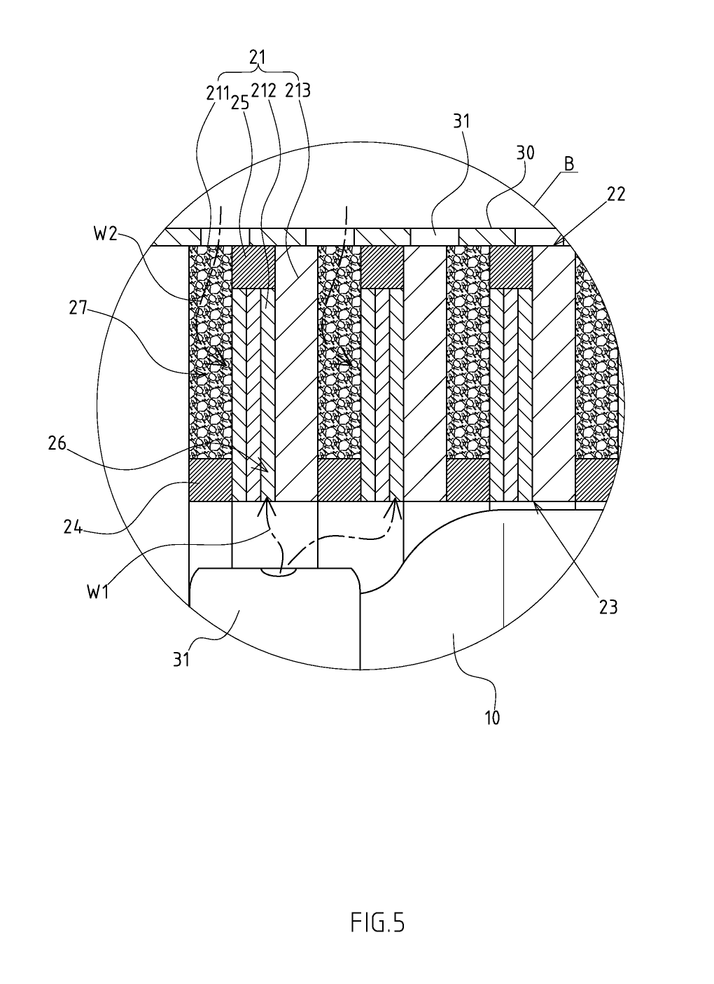

The power generating modules 21 of the present invention are superimposed to form a ring passage structure. Referring to FIG. 5, the hydrogen W1 released from hydrogen storage unit 10 is guided into MEA 212 via a hydrogen guide passage 26 nearby the metal isolating layer 213. On the other hand, oxygen W2 is guided from air hole 31 of enclosure 30 into MEA 212 via an oxygen guide passage 27 formed by diffusion layer 211. The flow passage of hydrogen W1 and oxygen W2 is divided through internal sealing member 24 of metal diffusion layer 211 and external sealing member 25 of MEA 212, in combination with the metal isolating layer 213. Thus, the hydrogen W1 and oxygen W2 gather into MEA 212 of power generating modules 21 to generate electrical energy through the expected chemical reaction.

We claim:

1. An integrated fuel cell, comprising:
an enclosure;
a fuel storage unit, being housed in said enclosure; and
a power generating unit, being comprised of a plurality of power generating modules, said power generating modules forming a passage, said passage connecting said fuel storage unit and said power generating unit, said power generating modules forming a fully-sealed or notched cylinder having an external wall and a hollow space, said passage of said power generating modules being superimposed and assembled into a hydrogen guide passage and oxygen guide passage by a misaligned internal sealing member and external sealing member, said power generating modules having hydrogen and oxygen guided separately into said power generating modules.

2. The fuel cell defined in claim 1, wherein said power generating modules have a round, rectangular or polygonal structure.

3. The fuel cell defined in claim 1, wherein said power generating modules are assembled in said enclosure.

4. The fuel cell defined in claim 3, wherein said enclosure has a plurality of air holes.

5. The fuel cell defined in claim 1, wherein said hollow space formed by said power generating modules accommodates a hydrogen storage unit.

6. The fuel cell defined in claim 1, wherein said hollow space formed by said power generating modules forms a hydrogen guide channel, said hollow space being linked to a hydrogen storage unit via pipeline.

7. The fuel cell defined in claim 1, wherein said power generating modules are superimposed by an annular metal diffusion layer, a MEA and a metal isolating layer, the internal sealing member being placed circularly within said annular metal diffusion layer, said external sealing member being placed circularly outside of said MEA, said oxygen guide passage being shaped by the metal diffusion layer, said hydrogen guide passage being shaped nearby a metal isolating layer of said MEA.

8. The fuel cell defined in claim 7, wherein said annular metal diffusion layer has a capillary structure formed by foamed metal materials.

9. The fuel cell defined in claim 1, wherein said hollow space formed by said power generating modules is comprised of a single hollow space or a double hollow space arranged at intervals.
